(19) United States
(12) Patent Application Publication
(10) Pub. No.: US 2021/0178338 A1
(43) Pub. Date: Jun. 17, 2021

(54) ULTRATHIN-FILM COMPOSITE MEMBRANE BASED ON THERMALLY REARRANGED POLY(BENZOXAZOLE-IMIDE) COPOLYMER, AND PRODUCTION METHOD THEREFOR

(71) Applicant: IUCF-HYU (INDUSTRY-UNIVERSITY COOPERATION FOUNDATION HANYANG UNIVERSITY ), Seoul (KR)

(72) Inventors: Young Moo LEE, Seoul (KR); Jihoon KIM, Seoul (KR); Sang Min LEE, Busan (KR); Sang Hyun PARK, Seoul (KR); Sun-ju MOON, Gumi-si (KR); Narae KANG, Gwangmyeong-si (KR); Jong Myoung LEE, Seoul (KR); Ju-Sung KIM, Incheon (KR); Juntae JUNG, Bucheon-si (KR)

(73) Assignee: IUCF-HYU (INDUSTRY-UNIVERSITY COOPERATION FOUNDATION HANYANG UNIVERSITY), Seoul (KR)

(21) Appl. No.: 16/079,836

(22) PCT Filed: Feb. 22, 2017
(86) PCT No.: PCT/KR2017/001938

§ 371 Date: Aug. 24, 2018

(30) Foreign Application Priority Data
Feb. 26, 2016 (KR) 10-2016-0023238
Feb. 17, 2017 (KR) 10-2017-0021377

(51) Int. Cl. B01D 69/12; B01D 71/56; B01D 71/64; B01D 61/00; B01D 61/02; B01D 67/00; B01D 69/08

(52) U.S. Cl. CPC B01D 69/122; B01D 2323/14; B01D 71/64; B01D 61/002; B01D 61/027; B01D 67/0018; B01D 69/087; B01D 67/0093; B01D 2325/04; B01D 2325/22; B01D 2325/24; B01D 2325/30; B01D 2325/20; B01D 2323/02; B01D 2323/08; B01D 71/56

(57) ABSTRACT

The present invention relates to an ultrathin-film composite membrane based on a thermally rearranged poly(benzoxazole-imide) copolymer and a production method therefor and to a technique for forming a porous support by means of a thermally rearranged poly(benzoxazole-imide)copolymer and then producing, on the porous support, an ultrathin-film composite membrane comprising a thin-film active layer. The ultrathin-film composite membrane produced according to the present invention has excellent thermal/chemical stability and mechanical physical properties, thus is not only capable of withstanding high operating pressure, but also capable of minimizing internal concentration polarization and thereby obtaining high water permeance and, as a result, high power density, and thus can be applied to a pressure-retarded osmosis or forward osmosis process. Further, said ultrathin-film composite membrane has excellent chemical/thermal stability against organic solvents, has superior organic solvent nano-filtration performance, particularly maintains nano-filtration performance stably even under a high-temperature organic solvent condition, and thus can be applied as an organic solvent nano-filtration membrane.

### TECHNICAL FIELD

The present disclosure relates to an ultrathin-film composite membrane based on a thermally rearranged poly(benzoxazole-imide) copolymer and a method for preparing the same. More particularly, the present disclosure relates to a technology of forming a porous support from the thermally rearranged poly(benzoxazole-imide) copolymer, providing a composite membrane including a thin-film active layer on the porous support, and applying the composite membrane to a pressure retarded osmosis, forward osmosis or organic solvent nano-filtration process.

### BACKGROUND ART

Recently, salinity gradient power generation using the osmotic pressure of the seawater for generating energy has been given many attentions. Particularly, active studies have been conducted about a pressure retarded osmosis process. The pressure retarded osmosis process is a method for generating electricity by using a difference in osmotic pressure between two solutions having a salinity gradient as driving force to apply pressure lower than the osmotic pressure toward the direction opposite to the direction of osmosis through a separation membrane so that the water flow toward the direction of osmosis may be retarded to allow the water passed through the separation membrane to drive a turbine.

A flat sheet membrane or hollow fiber membrane has been used largely as the separation membrane for such a pressure retarded osmosis process. In general, most of such membranes include a porous support based on polysulfone (PS) or polyethylene terephthalate (PET) and having a thickness of 100-200 μm, and an ultrathin-film composite membrane having a polyamide (PA)-based thin-film active layer with a thickness of about 100 nm (Patent Document 1).

However, in the case of a conventional separation membrane for a pressure retarded osmosis process, when water is passed through the membrane, salts of the introduced solutions are blocked by the active layer having selective permeability and are accumulated inside of the support, thereby causing concentration polarization, which is a phenomenon including an increase in salt concentration at the interface between the active layer and the support. Due to this, the concentration gradient as driving force of water permeation is decreased, resulting in a decreased in water permeance and degradation of power density. It is thought that this is mainly caused by such a large thickness of the support, 100-200 μm. In addition, it is required for the separation membrane for a pressure retarded osmosis process to resist high operating pressure, and thus to have excellent mechanical properties as well as thermal and chemical stability.

Meanwhile, a separation process required for the chemical industry and pharmaceutical industry includes such processes as distillation, crystallization, adsorption and extraction, which are generally carried out by using an organic solvent. Thus, there is a continuously increasing need for an organic solvent separation membrane. However, most separation membranes developed or commercialized to date have been produced for water treatment or gas separation. Therefore, such separation membranes have a limitation in retaining a stable chemical structure under the environment requiring exposure for various organic solvents. As a result, although there has been an industrial need for an organic solvent separation membrane and the scale thereof is not small, development of organic solvent separation membranes has been insufficient.

Merely, as an organic solvent nano-filtration membrane, a composite membrane having a polyamide thin-film formed on a polyimide support, a polybenzimidazole membrane polymerized from tetramine and dicarboxylic acid, a polyetheretherketone membrane are known. Particularly, in the case of an organic solvent nano-filtration membrane, its pore size is important but the interaction between a solvent or solute and the membrane affects the performance of the separation membrane. Thus, there is an imminent need for developing a material having excellent stability against organic solvents. In addition, although the conventional polyimide, crosslinked polybenzimidazole and polyetheretherketone membranes formed in the shape of an asymmetric membrane are stable against organic solvents, most of them cannot provide high permeance and are used in a limited range of organic solvents and temperatures. Therefore, there is a need for providing various types of separation membrane materials, various membrane shapes and improved separation performance (Patent Documents 2 and 3).

In addition, it is known that acid dianhydride, ortho-hydroxyamine and aromatic diamine are allowed to react to obtain a hydroxypolyimide-polyimide copolymer membrane, which, in turn, is heat treated to obtain a thermally rearranged poly(benzoxazole-imide) copolymer membrane used as a gas separation membrane. However, there is no disclosure about its performance of organic solvent separation including chemical stability against organic solvents. Thus, the copolymer membrane cannot be considered to be applied as an organic solvent nano-filtration membrane (Non-Patent Document 1).

Therefore, the present inventors have conducted many studies in order to broaden the application spectrum of a thermally rearranged poly(benzoxazole-imide) copolymer membrane having excellent thermal/chemical stability and mechanical properties. As a result, it has been found that when the thermally rearranged poly(benzoxazole-imide) copolymer membrane is provided as a porous support and a thin-film active layer is formed on the porous support to obtain an ultrathin-film composite membrane, the ultrathin-film composite membrane can be applied not only to a separation membrane for pressure retarded osmosis or forward osmosis process but also to an organic solvent nano-filtration membrane by virtue of its stability against organic solvents and separation performance. The present disclosure is based on this finding.

### REFERENCES

### Patent Documents

1. Korean Patent Publication No. 10-1391654
2. US Publication of Patent Application US 2015/0231572
3. US Publication of Patent Application US 2013/0118983

### Non-Patent Documents

Chul Ho Jung et al., J. Membr. Science 350, 301-309 (2010)

### DISCLOSURE

### Technical Problem

A technical problem to be solved by the present disclosure is to provide an ultrathin-film composite membrane based on a thermally rearranged poly(benzoxazole-imide) copolymer and a method for producing the same, wherein the thermally rearranged poly(benzoxazole-imide) copolymer has excellent thermal/chemical stability and mechanical properties so that it may resist even under high operating pressure, minimizes internal concentration polarization to provide high water permeance and high power density according thereto so that it may be applied to a pressure retarded osmosis or forward osmosis process, shows excellent chemical/thermal stability against organic solvents, and particularly maintains nano-filtration performance even under the condition of a high-temperature organic solvent so that it may be applied to an organic solvent nano-filtration process.

### Technical Solution

In one general aspect, there is provided an ultrathin-film composite membrane including: a porous thermally rearranged poly(benzoxazole-imide) copolymer support having a repeating unit represented by the following Chemical Formula 1; and a thin-film active layer formed on the support.

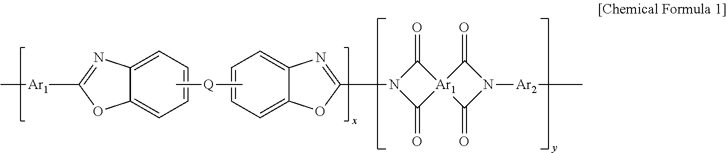

wherein Ar₁ is an aromatic cyclic group selected from a substituted or non-substituted tetravalent C6-C24 arylene group and a substituted or non-substituted tetravalent C4-C24 heterocyclic group, wherein the aromatic cyclic group is present alone; two or more aromatic cyclic groups may form a condensed ring; or two or more aromatic cyclic groups may be linked by means of a single bond, O, S, CO, SO₂, Si(CH₃)₂, (CH₂)ₚ (1≤P≤10), (CF₂)_{q} (1≤q≤10), C(CH₃)₂, C(CF₃)₂ or CO—NH;

Ar₂ is an aromatic cyclic group selected from a substituted or non-substituted divalent C6-C24 arylene group and a substituted or non-substituted divalent C4-C24 heterocyclic group, wherein the aromatic cyclic group is present alone; two or more aromatic cyclic groups may form a condensed ring; or two or more aromatic cyclic groups may be linked by means of a single bond, O, S, CO, SO₂, Si(CH₃)₂, (CH₂)ₚ (1≤P≤10), (CF₂)_{q} (1≤q≤10), C(CH₃)₂, C(CF₃)₂ or CO—NH;

Q is a single bond, O, S, CO, SO₂, Si(CH₃)₂, (CH₂)ₚ (1≤P≤10), (CF₂)_{q} (1≤q≤10), C(CH₃)₂, C(CF₃)₂, CO—NH, C(CH₃)(CF₃), or substituted or non-substituted phenylene group; and

each of x and y represents a molar fraction in the repeating unit, wherein 0.1≤x≤0.9, 0.1≤y≤0.9, and x+y=1.

The porous thermally rearranged poly(benzoxazole-imide) copolymer support may be an electrospun membrane or hollow fiber membrane.

The electrospun membrane may have a thickness of 10-80 μm and a porosity of 60-80%.

The active layer of the thin-film may be an aromatic polyamide having a repeating unit represented by the following Chemical Formula 2.

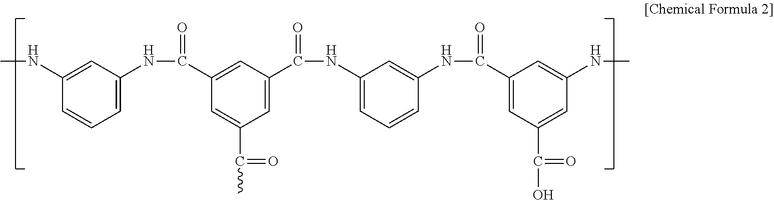

The active layer of the thin-film may have a thickness of 50-300 nm.

The ultrathin-film composite membrane may be for use in a pressure retarded osmosis process.

The ultrathin-film composite membrane may be for use in a forward osmosis process.

The ultrathin-film composite membrane may be for use in nano-filtration of organic solvents.

In another aspect, there is provided a method for producing an ultrathin-film composite membrane, including the steps of:

I) carrying out reaction of acid dianhydride, ortho-hydroxydiamine and aromatic diamine to obtain polyamic acid solution and forming a hydroxyl group-containing polyimide-polyimide copolymer through an azeotropic thermal imidization process;

II) forming a membrane from a polymer solution containing the hydroxyl group-containing polyimide-polyimide copolymer of step I) dissolved in an organic solvent through an electrospinning process or non-solvent induced phase separation process;

III) carrying out thermal rearrangement of the membrane obtained from step II) to obtain a porous thermally rearranged poly(benzoxazole-imide) copolymer support having a repeating unit represented by the above Chemical Formula 1; and

IV) forming an active layer on the support by using a crosslinked aromatic polyamide thin film having a repeating unit represented by the above Chemical Formula 2.

The acid dianhydride in step I) may be represented by the following Chemical Formula 3.

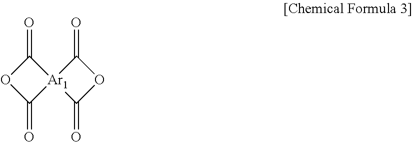

wherein Ar₁ is the same as defined in the above Chemical Formula 1.

The ortho-hydroxydiamine in step I) may be represented by the following Chemical Formula 4.

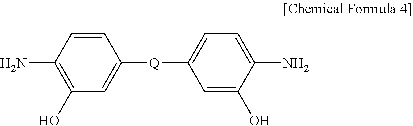

wherein Q is the same as defined in the above Chemical Formula 1.

The aromatic diamine in step I) may be represented by the following Chemical Formula 5.

H₂N—Ar₂—NH₂ [Chemical Formula 5]

wherein Ar₂ is the same as defined in the above Chemical Formula 1.

The thermal rearrangement in step III) may be carried out by increasing the temperature to 300-400° C. at a warming rate of 1-20° C./min and maintaining the isothermal state for 1-2 hours under a high purity inert gas atmosphere.

The method may further include a step of carrying out hydrophilization treatment of the support obtained from step III) before carrying out step Iv).

The method may further include a step of carrying out post-treatment of the ultrathin-film composite membrane obtained from step IV) with aqueous sodium hypochlorite.

### Advantageous Effects

The ultrathin-film composite membrane having a thin-film active layer formed on a porous thermally rearranged poly(benzoxazole-imide) copolymer support according to the embodiments of the present disclosure has excellent thermal/chemical stability and mechanical properties so that it may resist even under high operating pressure, minimizes internal concentration polarization to provide high water permeance and high power density according thereto so that it may be applied to pressure retarded osmosis or forward osmosis process. In addition, the ultrathin-film composite membrane according to the present disclosure shows excellent chemical/thermal stability against organic solvents and organic solvent nano-filtration performance, and particularly maintains nano-filtration performance stably even under the condition of a high-temperature organic solvent so that it may be used as an organic solvent nano-filtration membrane.

### BRIEF DESCRIPTION OF DRAWINGS

FIG. 1 illustrates the process for producing the porous thermally rearranged poly(benzoxazole-imide) copolymer supports (electrospun membrane) according to Examples 1-9 and scanning electron microscopic (SEM) images thereof.

FIG. 2 illustrates the attenuated total reflectance-infrared ray (ATR-IR) spectrum of the porous thermally rearranged poly(benzoxazole-imide) copolymer support according to each of Examples 1-9.

FIG. 3 illustrates the ATR-IR spectrum of each of the porous thermally rearranged poly(benzoxazole-imide) copolymer support (a) according to Example 1 and the ultrathin-film composite membrane (b) according to Example 11.

FIG. 4 is a thermogravimetric analysis (TGA) graph illustrating the weight reduction characteristics of the porous thermally rearranged poly(benzoxazole-imide) copolymer support according to Example 1 depending on thermal rearrangement conditions.

FIG. 5 is a photographic image illustrating the results of observation of the stability of the porous thermally rearranged poly(benzoxazole-imide) copolymer support according to Example 1 against an organic solvent.

FIG. 6 illustrates the SEM images of the surface, active layer and the total membrane of each of the commercially available polysulfone-based composite membrane (a) for reverse osmosis, cellulose-based ultrathin-film composite membrane (b) for forward osmosis and the ultrathin-film composite membrane (c) according to Example 11.

FIG. 7 is a graph illustrating the water permeance and salt rejection ratio of the ultrathin-film composite membrane according to Example 11 before and after the post-treatment (500 ppm NaOCl, 1000 ppm NaOCl) [charge: 2000 ppm NaCl (20° C.)].

FIG. 8 is a graph illustrating the water permeation amount and power density of the ultrathin-film composite membrane according to an embodiment of the present disclosure [inducing solution: 1M NaCl (20° C.), charge: deionized water (20° C.)].

FIG. 9 is a graph illustrating the pure solvent permeance test results of the porous thermally rearranged poly(benzoxazole-imide) copolymer support according to Example 1.

FIG. 10 illustrates the results of the observing a change in shape and structure of the porous thermally rearranged poly(benzoxazole-imide) copolymer support according to Example 1 in high-temperature DMF [(a) graph of dimensional change, (b) photograph taken by the naked eyes, (c) scanning electron microscopic (SEM) image].

FIG. 11 is a graph illustrating the THF permeance (a) and rejection ratio (b) of the ultrathin-film composite membrane according to Example 11.

FIG. 12 is a graph illustrating the DMF permeance (a) and rejection ratio (b) of the ultrathin-film composite membrane according to Example 11.

FIG. 13 is a graph illustrating the high-temperature DMF permeance (a) and rejection ratio (b) of the ultrathin-film composite membrane according to Example 11.

FIG. 14 is a scanning electron microscopic (SEM) image of the morphology of the ultrathin-film composite membrane according to Example 11, taken before and after using the membrane as an organic solvent nano-filtration membrane.

### BEST MODE

In one aspect, there is provided an ultrathin-film composite membrane including: a porous thermally rearranged poly(benzoxazole-imide) copolymer support having a repeating unit represented by the following Chemical Formula 1; and a thin-film active layer formed on the support.

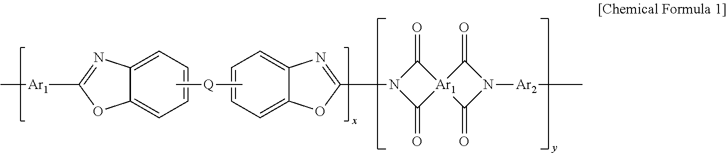

wherein Ar₁ is an aromatic cyclic group selected from a substituted or non-substituted tetravalent C6-C24 arylene group and a substituted or non-substituted tetravalent C4-C24 heterocyclic group, wherein the aromatic cyclic group is present alone; two or more aromatic cyclic groups may form a condensed ring; or two or more aromatic cyclic groups may be linked by means of a single bond, O, S, CO, SO₂, Si(CH₃)₂, (CH₂)ₚ (1≤P≤10), (CF₂)_{q} (1≤q≤10), C(CH₃)₂, C(CF₃)₂ or CO—NH;

Ar₂ is an aromatic cyclic group selected from a substituted or non-substituted divalent C6-C24 arylene group and a substituted or non-substituted divalent C4-C24 heterocyclic group, wherein the aromatic cyclic group is present alone; two or more aromatic cyclic groups may form a condensed ring; or two or more aromatic cyclic groups may be linked by means of a single bond, O, S, CO, SO₂, Si(CH₃)₂, (CH₂)ₚ (1≤P≤10), (CF₂)_{q} (1≤q≤10), C(CH₃)₂, C(CF₃)₂ or CO—NH;

Q is a single bond, O, S, CO, SO₂, Si(CH₃)₂, (CH₂)ₚ (1≤P≤10), (CF₂)_{q} (1≤q≤10), C(CH₃)₂, C(CF₃)₂, CO—NH, C(CH₃)(CF₃), or substituted or non-substituted phenylene group; and

each of x and y represents a molar fraction in the repeating unit, wherein 0.1≤x≤0.9, 0.1≤y≤0.9, and x+y=1.

It can be seen that the porous thermally rearranged poly(benzoxazole-imide) copolymer support has excellent chemical/thermal stability by virtue of the structure of the repeating unit as defined in the above Chemical Formula 1.

In addition, preferably, the porous thermally rearranged poly(benzoxazole-imide) copolymer support is an electrospun membrane or hollow fiber membrane. In general, the electrospun membrane can be formed into a porous support having high porosity with a small thickness and interconnected pore structure by stacking fibers having a size of several hundreds of nanometers in a bottom-up mode through an electrospinning process. Therefore, according to the present disclosure, when the porous thermally rearranged poly(benzoxazole-imide) copolymer support is an electrospun membrane, it may have a thickness of 10-80 μm and a porosity of 60-80% preferably.

Since the polysulfone-based or polyethylene terephthalate-based porous support of the ultrathin-film composite membrane used conventionally as a separation membrane for water treatment has a large thickness of 100-200 μm, internal concentration polarization occurs inside of such a thick porous support, when it is used as a separation membrane for a pressure retarded osmosis process for generating energy or a forward osmosis process for producing water, resulting in a decrease in concentration gradient, which is driving force of water permeation. As a result, there have been problems of degradation of water permeance and a decrease in power density according thereto.

Therefore, when using the porous support obtained as an electrospun membrane and having a small thickness of 10-80 μm and a significantly high porosity of 60-80% according to the present disclosure, it is possible to minimize internal concentration polarization and to obtain high water permeance and high power density according thereto. Thus, it is possible to apply the membrane to a pressure retarded osmosis or forward osmosis process and to minimize mass transport resistance. As a result, the membrane not only has excellent chemical/thermal stability but also may be applied as an organic solvent nano-filtration membrane.

Herein, when the porous support obtained as an electrospun membrane has a thickness less than 10 μm, such an excessively small thickness may cause degradation of mechanical properties. When the porous support has a thickness larger than 80 μm, concentration polarization may occur in the support or mass transport resistance may be increased undesirably. In addition, when the porous support has a porosity less than 60%, water permeance or organic solvent separation performance may be degraded. When the porosity is larger than 80%, it is difficult to form a membrane.

The active layer of the thin-film formed on the porous support may be a crosslinked aromatic polyamide having a repeating unit represented by the following Chemical Formula 2.

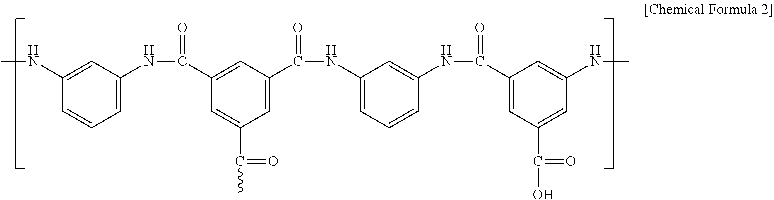

Preferably, the active layer of the thin-film has a thickness of 50-300 nm. When the active layer has a thickness less than 50 nm, it is difficult for the membrane to resist high operating pressure when it is applied to a pressure retarded osmosis process. When the active layer has a thickness larger than 300 nm, water permeance or mass transport resistance may be degraded.

In addition, the structure of the poly(benzoxazole-imide) copolymer is based on the synthesis of polyimide prepared by imidizing polyamic acid obtained from the reaction of acid dianhydride with diamine. Further, the thermally rearranged polybenzoxazole is obtained by allowing the functional group, such as hydroxyl group, present at the ortho-position of the aromatic imide connection ring to attack the carbonyl group of the imide ring to form a carboxy-benzoxazole intermediate, and then carrying out decarboxylation through heat treatment. Thus, the present disclosure provides a method for producing an ultrathin-film composite membrane including the following steps.

In another aspect, there is provided a method for producing an ultrathin-film composite membrane, including the steps of:

I) carrying out reaction of acid dianhydride, ortho-hydroxydiamine and aromatic diamine to obtain polyamic acid solution and forming a hydroxyl group-containing polyimide-polyimide copolymer through an azeotropic thermal imidization process;

II) forming a membrane from a polymer solution containing the hydroxyl group-containing polyimide-polyimide copolymer of step I) dissolved in an organic solvent through an electrospinning process or non-solvent induced phase separation process;

III) carrying out thermal rearrangement of the membrane obtained from step II) to obtain a porous thermally rearranged poly(benzoxazole-imide) copolymer support having a repeating unit represented by the above Chemical Formula 1; and

IV) forming an active layer on the support by using a crosslinked aromatic polyamide thin film having a repeating unit represented by the above Chemical Formula 2.

In general, acid dianhydride is allowed to react with diamine to obtain polyimide. Thus, according to the present disclosure, the compound represented by the following Chemical Formula 3 is used as acid dianhydride.

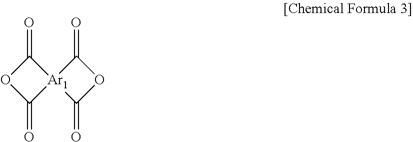

wherein Ar₁ is the same as defined in the above Chemical Formula 1.

Any acid dianhydride represented by Chemical Formula 3 may be used as a monomer for preparing polyimide with no particular limitation. However, in view of improvement of the thermal/chemical properties of the resultant polyimide, it is preferred to use 4,4′-hexafluoroisopropylidene phthalic dianhydride (6FDA) or 4,4′-oxydiphthalic dianhydride (ODPA) having a fluoro group.

In addition, according to the present disclosure, the copolymer ultimately has a poly(benzoxazole-imide) copolymer structure. Thus, considering that a polybenzoxazole unit can be introduced by thermal rearrangement of ortho-hydroxypolyimide, the compound represented by the following Chemical Formula 4 is used as an ortho-hydroxydiamine in order to obtain ortho-hydroxypolyimide.

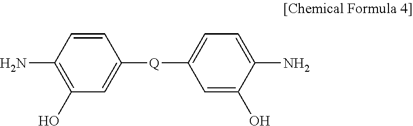

wherein Q is the same as defined in the above Chemical Formula 1. Any ortho-hydroxydiaime represented by Chemical Formula 4 may be used with no particular limitation. However, in view of improvement of the thermal/chemical properties of the resultant polyimide, it is preferred to use 2,2-bis(3-amino-4-hydroxyphenyl)hexafluoropropane (APAF) or 3,3′-diamino-4,4′-dihydroxybiphenyl (HAB) having a fluoro group.

Further, according to the present disclosure, the aromatic diamine represented by the following Chemical Formula 5 may be used as a to comonomer, which is allowed to react with the acid dianhydride represented by Chemical Formula 3 and ortho-hydroxydiamine represented by Chemical Formula 4 to obtain the hydroxyl group-containing polyimide-polyimide copolymer.

H₂N—Ar₂—NH₂ [Chemical Formula 5]

wherein Ar₂ is the same as defined in the above Chemical Formula 1.

Any aromatic diamine represented by Chemical Formula 5 may be used with no particular limitation. However, it is preferred to use 4,4′-oxydianiline (ODA) or 2,4,6-trimethylphenylene diamine (DAM).

In other words, in step I), the acid dianhydride of Chemical Formula 3, ortho-hydroxydiamine of Chemical Formula 4 and aromatic diamine of Chemical Formula 5 are dissolved and agitated in an organic solvent such as N-methyl pyrrolidone (NMP) to obtain polyamic acid solution, which, in turn, is subjected to azeotropic thermal imidization to provide a hydroxyl group-containing polyimide-polyimide copolymer represented by the following General Formula 1.

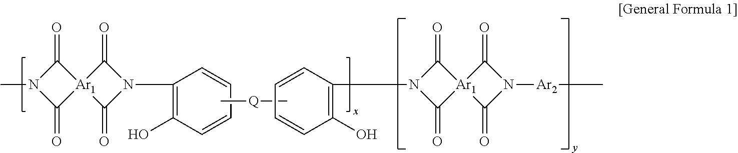

wherein Ar₁, Ar₂, Q, x and y are the same as defined in Chemical Formula 1.

Herein, the azeotropic thermal imidization method is carried out by adding toluene or xylene to the polyamic acid solution, agitating the mixture and performing imidization at 160-200° C. for 6-24 hours. During this, water released while an imide ring is formed is separated as an azeotropic mixture of toluene or xylene.

Then, the hydroxyl group-containing polyimide-polyimide copolymer of step I) represented by General Formula 1 is dissolved in an organic solvent such as N-methyl pyrrolidone (NMP) to provide a polymer solution, which, in turn, is formed into a film through a conventional electrospinning or non-solvent induced phase separation process to obtain an electrospun membrane or hollow fiber membrane as a support.

Then, the hydroxyl group-containing polyimide-polyimide copolymer electrospun membrane or hollow fiber membrane is thermally rearranged to obtain a porous thermally rearranged poly(benzoxazole-imide) copolymer support having a repeating unit represented by Chemical Formula 1.

Herein, the thermal rearrangement is carried out by increasing the temperature to 300-400° C. at a warming rate of 1-20° C./min and maintaining the isothermal state for 1-2 hours under a high purity inert gas atmosphere.

Finally, an active layer of the crosslinked aromatic polyamide thin-film having a repeating unit represented by Chemical Formula 2 is formed on the porous thermally rearranged poly(benzoxazole-imide) copolymer support having a repeating unit represented by Chemical Formula 1 to obtain the target ultrathin-film composite membrane according to the present disclosure.

Herein, the active layer of the crosslinked aromatic polyamide having a repeating unit represented by Chemical Formula 2 is preferably formed by interfacial polymerization of meta-phenylene diamine (MPD) with trimesoyl chloride (TMC) according to the following Reaction Scheme 1.

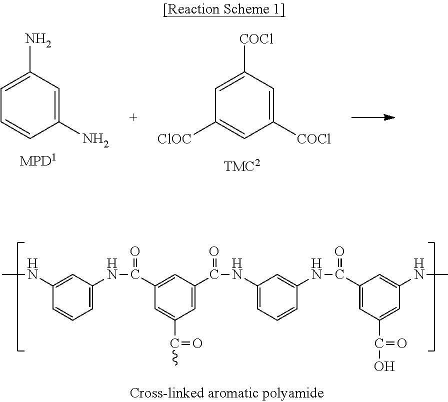

Meanwhile, according to an embodiment, before forming the active layer of the crosslinked aromatic polyamide thin-film on the porous thermally rearranged poly(benzoxazole-imide) copolymer support, the support may be hydrophilized to facilitate formation of the thin-film active layer. For the hydrophilization treatment of the support, various methods, such as known polydopamine (PDA) coating, polyvinyl alcohol (PVA) coating or plasma coating, may be used. Particularly, it is preferred to carry out hydrophilization by coating the support with polydopamine.

Actually, after carrying out hydrophilization by coating the porous thermally rearranged poly(benzoxazole-imide) copolymer support with polydopamine according to an embodiment of the present disclosure, the contact angle is decreased by about two times from 114° before coating to 58° after coating. This demonstrates that hydrophilization treatment is made clearly. Also, it can be seen that the porous thermally rearranged poly(benzoxazole-imide) copolymer support is coated with polydopamine by observing hydroxyl groups and acetal groups through attenuated total reflectance-infrared ray (ATR-IR) analysis.

In addition, the above-described method for producing an ultrathin-film composite membrane may further include a step of carrying out post-treatment of the ultrathin-film composite membrane obtained from step IV) with aqueous sodium hypochlorite. Through the post-treatment step, the crosslinked polyamide thin-film on the porous support undergoes decomposition of polyamide as shown in the following Reaction Scheme 2.

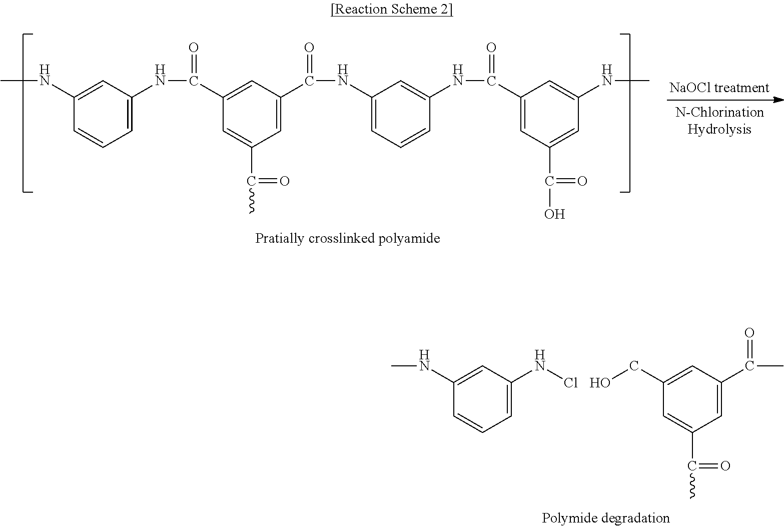

Exemplary embodiments now will be described more fully hereinafter with reference to the accompanying drawings.

### [Preparation Example 1] Preparation of Hydroxyl Group-Containing Polyimide-Polyimide Copolymer

First, 5.0 mmol of 3,3′-diamino-4,4′-dihydroxybiphenyl (HAB) and 5.0 mmol of 4,4′-oxydianiline (ODA) were dissolved in 10 mL of dry NMP, the resultant mixture was cooled to 0° C., and then 10.0 mmol of 4,4′-oxydiphthalic dianhydride (ODPA) dissolved in 10 mL of dry NMP was added thereto. The reaction mixture was agitated at 0° C. for 15 minutes, warmed to room temperature and allowed to stand overnight to obtain viscous polyamic acid solution. Then, 20 mL of ortho-xylene was added to the polyamic acid solution and the resultant mixture was agitated vigorously and heated to carry out imidization at 180° C. for 6 hours. During this, water released by the formation of an imide ring was separated as an azeotropic mixture with xylene. The resultant brown-colored solution was subjected to a series of processes including cooling to room temperature, precipitation in distilled water, washing several times with hot water and drying in a convection oven at 120° C. for 12 hours to obtain a hydroxyl group-containing polyimide-polyimide copolymer represented by the following Chemical Formula 6, designated as ODPA-HAB₅-ODA₅.

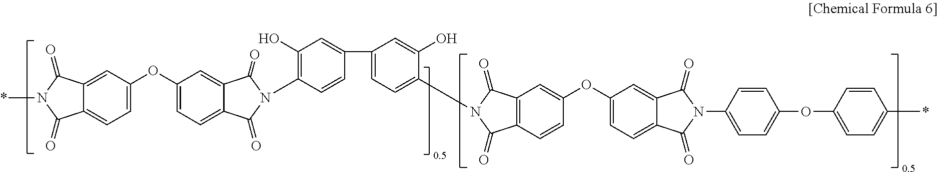

Synthesis of the hydroxyl group-containing polyimide-polyimide copolymer represented by Chemical Formula 6 according to Preparation Example 1 was demonstrated by ¹H-NMR and FT-IR data as follows. ¹H-NMR (300 MHz, DMSO-d₆, ppm): 10.41 (s, —OH), 8.10 (d, Hₐᵣ, J=8.0 Hz), 7.92 (d, Hₐᵣ, J=8.0 Hz), 7.85 (s, Hₐᵣ), 7.80 (5, Hₐᵣ), 7.71 (S, Hₐᵣ), 7.47 (S, Hₐᵣ), 7.20 (d, Hₐᵣ, J=8.3 Hz), 7.04 (d, Hₐᵣ, J=8.3 Hz). FT-IR (film): v(O—H) at 3400 cm⁻¹, v(C═O) at 1786 and 1705 cm⁻¹, Ar (C—C) at 1619, 1519 cm⁻¹, imide v(C—N) at 1377 cm⁻¹, imide (C—N—C) at 1102 and 720 cm⁻¹.

### [Preparation Examples 2-9] Preparation of Hydroxyl Group-Containing Polyimide-Polyimide Copolymers

Preparation Example 1 was repeated to obtain hydroxyl group-containing polyimide-polyimide copolymers, except that various acid dianhydrides, ortho-hydroxyldiamines and aromatic diamines as shown in the following Table 1 were used. Each of the resultant samples was designated in the same manner as described in Preparation Example 1.

TABLE 1

| Preparation | | |
|---|---|---|
| Example | Sample Name | Molar Fraction |
| Prep. Ex. 2 | ODPA-HAB₈-ODA₂ | X = 0.8, y = 0.2 |
| Prep. Ex. 3 | 6FDA-APAF₈-ODA₂ | X = 0.8, y = 0.2 |
| Prep. Ex. 4 | 6FDA-APAF₅-DAM₅ | X = 0.5, y = 0.5 |
| Prep. Ex. 5 | 6FDA-HAB₅-ODA₅ | X = 0.5, y = 0.5 |
| Prep. Ex. 6 | 6FDA-HAB₈-ODA₂ | X = 0.8, y = 0.2 |
| Prep. Ex. 7 | 6FDA-HAB₅-DAM₅ | X = 0.5, y = 0.5 |
| Prep. Ex. 8 | 6FDA-APAF₂-ODA₈ | X = 0.2, y = 0.8 |
| Prep. Ex. 9 | 6FDA-APAF₅-ODA₅ | X = 0.5, y = 0.5 |

6FDA (4,4′-hexafluoroisopropylidene phthalic dianhydride)
APAF (2,2-bis(3-amino-4-hydroxyphenyl)hexafluoropropane
DAM (2,4,6-trimethylphenylene diamine)

### [Example 1] Preparation of Thermally Rearranged Poly(Benzoxazole-Imide) Copolymer Support (Electrospun Membrane)

ODPA-HAB₅-ODA₅ obtained from Preparation Example 1 was dissolved in dimethyl acetamide (DMAc) to prepare 10 wt % solution. Next, 6 mL of the polymer solution was charged to a 10 mL syringe equipped with a 23G needle and the syringe was mounted to the syringe pump of an electrospinning system (ES-robot, NanoNC, Korea). Then, spinning was carried out under the conventional electrospinning conditions to obtain an electrospun membrane (HPI).

The resultant electrospun membrane was inserted between an alumina sheet and carbon cloth, the temperature was increased to 400° C. at a rate of 3° C./min under high-purity argon gas atmosphere, and then the isothermal state was maintained at 400° C. for 2 hours to carry out thermal rearrangement, thereby providing a thermally rearranged poly(benzoxazole-imide) copolymer electrospun membrane (PBO) represented by the following Chemical Formula 7.

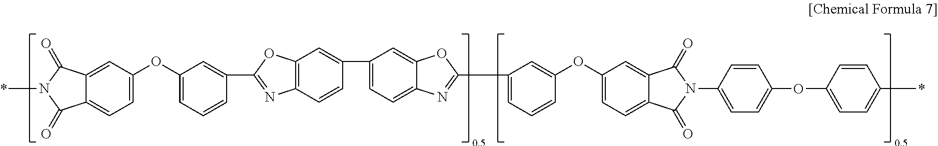

### [Examples 2-9] Preparation of Thermally Rearranged Poly(Benzoxazole-Imide) Copolymer Support (Electrospun Membrane)

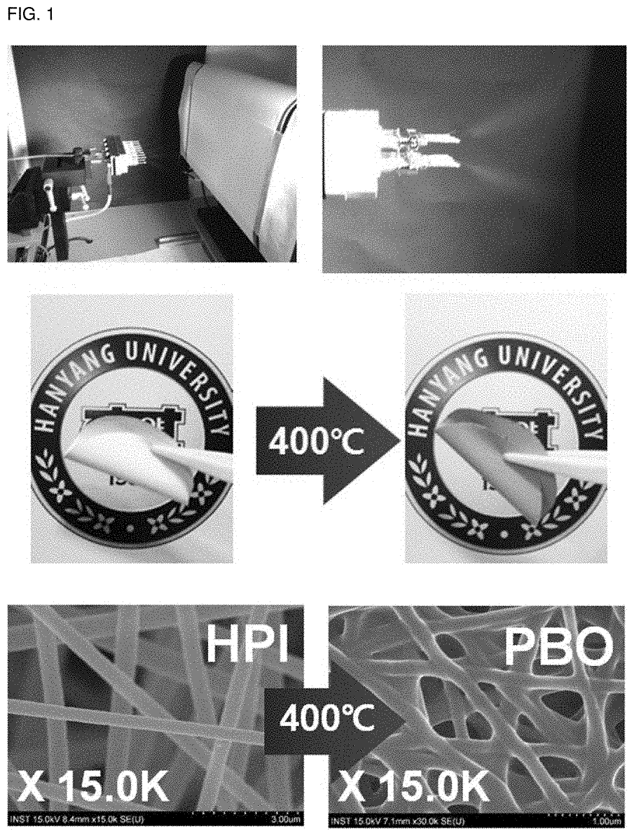

Each of the samples obtained from Preparation Examples 2-9 was used to obtain each of the thermally rearranged poly(benzoxazole-imide) copolymer electrospun membranes as shown in FIG. 1 in the same manner as Example 1. It can be seen from FIG. 1, which illustrates the process for producing the porous thermally rearranged poly(benzoxazole-imide) copolymer supports (electrospun membrane) according to Examples 1-9 and scanning electron microscopic (SEM) images thereof, that nanofibrous porous electrospun membranes were formed.

### [Example 10] Preparation of Thermally Rearranged Poly(Benzoxazole-Imide) Copolymer Support (Hollow Fiber Membrane)

A doping solution for forming hollow fibers was prepared from the ODPA-HAB₅-ODA₅ obtained from Preparation Example 1 [composition of doping solution: ODPA-HAB₅-ODA₅ 25 wt %, mixture of N-methyl pyrrolidone (NMP) with propionic acid (PA) (NMP:PA=50:50 mol %) 65 wt %, ethylene glycol 10 wt %]. Then, the doping solution was supplied and ejected (air gap: 5 cm) together with Bohr solution (water) through a double spinning nozzle to obtain a hollow fiber membrane according to the conventional non-solvent induced phase separation method (NIPS). The resultant hollow fiber membrane was warmed to 400° C. at a rate of 10° C./min, and the isothermal state was maintained at 400° C. for 2 hours to obtain a thermally rearranged (benzoxazole-imide) copolymer.

### [Example 11] Preparation of Ultrathin-Film Composite Membrane Including Thermally Rearranged Poly(Benzoxazole-Imide) Copolymer Support

The thermally rearranged poly(benzoxazole-imide) copolymer electrospun membrane obtained from Example 1 was coated with polydopamine (PDA) to carry out hydrophilization and then dipped into aqueous meta-phenylene diamine (MPD) solution. After removing an excessive amount of solution, 0.15% trimesoyl chloride hexane solution was poured to the surface of the support to carry out interfacial polymerization. Then, hexane was washed and the resultant product was allowed to stand in air and cured in an oven at 90° C. to obtain an ultrathin-film composite membrane having a crosslinked polyamide thin-film active layer formed on the thermally rearranged poly(benzoxazole-imide) copolymer support (electrospun membrane).

### [Example 12] Preparation of Ultrathin-Film Composite Membrane Including Thermally Rearranged Poly(Benzoxazole-Imide) Copolymer Support

The thermally rearranged poly(benzoxazole-imide) copolymer hollow fiber membrane obtained from Example 10 was used as a support and 3.5 wt % aqueous meta-phenylene diamine (MPD) solution was allowed to flow into the hollow fibers. After removing an excessive amount of solution, 0.15% trimesoyl chloride hexane solution was allowed to flow into the hollow fibers to carry out interfacial polymerization. Then, an excessive amount of solution was removed again and the resultant product was allowed to stand in air and dried to obtain an ultrathin-film composite membrane having a crosslinked polyamide thin-film active layer formed on the thermally rearranged poly(benzoxazole-imide) copolymer support (hollow fiber membrane).

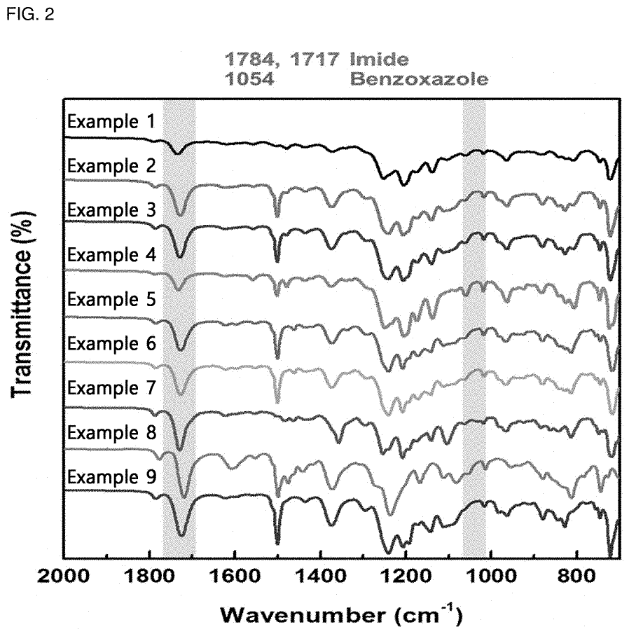

FIG. 2 illustrates the attenuated total reflectance-infrared ray (ATR-IR) spectrum of the porous thermally rearranged poly(benzoxazole-imide) copolymer support according to each of Examples 1-9. It can be seen that O—H stretching peaks appearing at around 1480 cm⁻¹ and 1054 cm⁻¹ have disappeared and two clear peaks derived from a typical benzoxazole ring have appeared. This suggests that a benzoxazole ring was formed during the heat treatment process. In addition, absorption bands unique to an imide group are observed at around 1784 cm⁻¹ and 1717 cm⁻¹. This demonstrates excellent thermal stability of an aromatic imide connection ring even under a high thermal rearrangement temperature of 400° C.

The following Table 2 shows the mechanical properties, average pore diameter, porosity and water permeance of the thermally rearranged poly(benzoxazole-imide) copolymer support (electrospun membrane) according to Example 1 as a function of thickness.

TABLE 2

| | Mechanical properties | | | | |
|---|---|---|---|---|---|
| | (MD/TD) | | Average | | |
| | Tensile | | pore | | Water |
| Thickness | strength | Elongation | diameter | | permeance |
| (μm) | (Mpa) | (%) | (μm) | Porosity (%) | (LMH) |
| 20 | 35/51 | 11/28 | 0.22 | 75 | 8541 |
| 40 | 23/29 | 6/13 | 0.20 | 64 | 3304 |
| 60 | 23/34 | 5/12 | 0.12 | 61 | 2334 |

MD: machine direction,
TD: transverse direction

It can be seen from Table 2 that the thermally rearranged poly(benzoxazole-imide) copolymer support according to the present disclosure has excellent mechanical properties, even though it has a significantly smaller thickness than the thickness (100-200 μm) of the conventional porous support applied as a membrane for water treatment, and has significantly high porosity, and thus provides significantly improved water permeance.

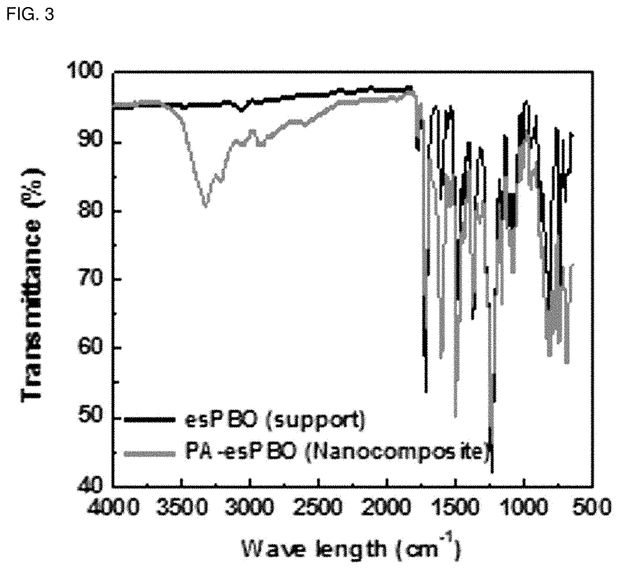

In addition, FIG. 3 illustrates the ATR-IR spectrum of each of the porous thermally rearranged poly(benzoxazole-imide) copolymer support (a) according to Example 1 and the ultrathin-film composite membrane (b) according to Example 11. As shown in FIG. 3, unlike the porous thermally rearranged poly(benzoxazole-imide) copolymer support (a) according to Example 1, the ultrathin-film composite membrane (b) according to Example 11 shows N—H stretching vibration at around 3444 cm⁻¹ and 3310 cm⁻¹, and C═O stretching and N—H plane bending at around 1667 cm⁻¹ and 1542 cm⁻¹, respectively.

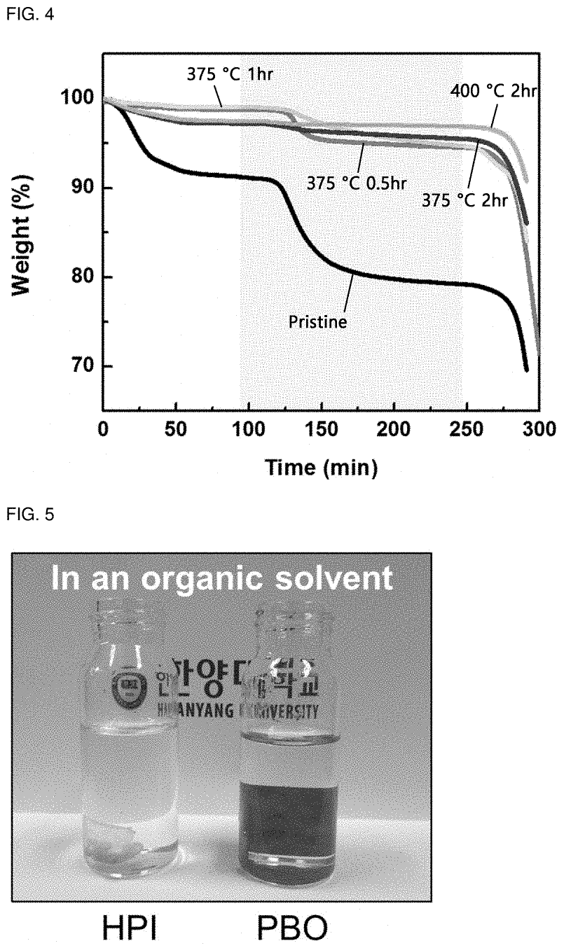

FIG. 4 is a thermogravimetric analysis (TGA) graph illustrating the weight reduction characteristics of the porous thermally rearranged poly(benzoxazole-imide) copolymer support according to Example 1 depending on various thermal rearrangement conditions (0.5 hours at 375° C., 1 hours at 375° C., 2 hours at 375° C., 2 hours at 400° C.). The thermogravimetric analysis was carried out by heating a sample to 400° C. at a rate of 10° C./min, maintaining the sample at 400° C. for 2 hours and heating the sample to 800° C. In general, weight reduction caused by thermal rearrangement is about 9% when thermal rearrangement is completed to 100% theoretically. As can be seen from FIG. 4, the weight reduction of pristine (support before thermal rearrangement) is 10% between 40 min and 160 min. This suggests that thermal rearrangement was performed smoothly. In addition, it is possible to calculate the thermal rearrangement degree of each treated support reversely from the quantitative weight reduction data thereof under each thermal rearrangement condition.

In addition, FIG. 5 is a photographic image illustrating the results of observation of the stability of the porous thermally rearranged poly(benzoxazole-imide) copolymer support according to Example 1 against an organic solvent. The organic solvent, dimethyl acetamide (DMAc), used for forming a membrane was used to carry out a chemical stability test. It can be seen from the test that the support (HPI) before thermal rearrangement was dissolved in the organic solvent, while the support (PBO) after thermal rearrangement was not dissolved in the organic solvent but retains its shape.

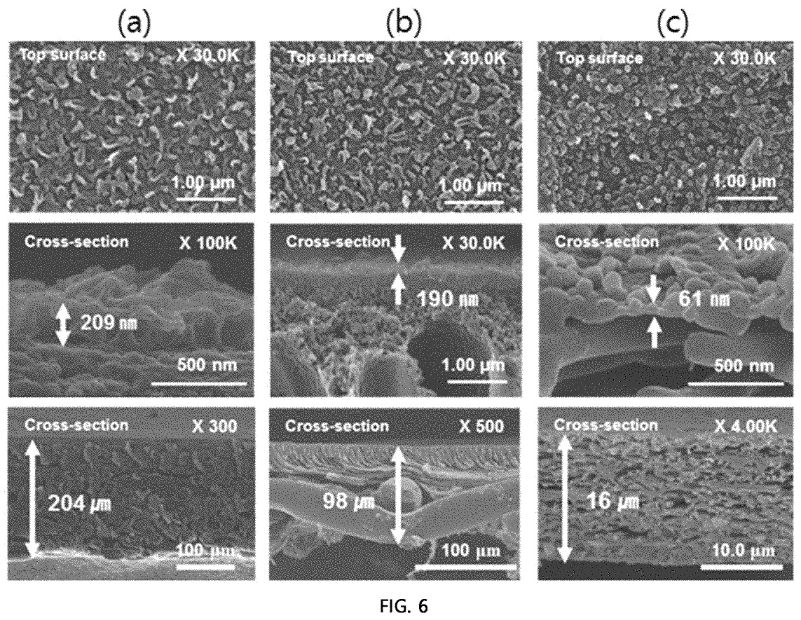

FIG. 6 illustrates the SEM images of the surface, active layer and the total membrane of each of the commercially available polysulfone-based composite membrane (a) for reverse osmosis, cellulose-based ultrathin-film composite membrane (b) for forward osmosis and the ultrathin-film composite membrane (c) according to Example 11. It can be seen that an ultrathin-film composite membrane having a polyamide thin-film layer formed thereon was prepared according to Example 11 and the polyamide thin-film layer has a thickness of 60 nm, which is about 3 times smaller than the thickness (209 nm) of the conventional polysulfone-based composite membrane for reverse osmosis. It can be also seen that the total thickness of the membrane is 16 μm, which is at least 12 times smaller than the total thickness (204 μm) of the conventional polysulfone-based composite membrane for reverse osmosis. In other words, it can be seen from FIG. 6 that the ultrathin-film composite membrane according to Example 11 has a significantly smaller thickness as compared to the conventional polysulfone-based composite membrane for reverse osmosis and cellulose-based ultrathin-film composite membrane, has a porous structure, and the active layer thereof is significantly thin, thereby minimizing concentration polarization occurring in the composite membrane and mass transport resistance. Therefore, it can be expected that the ultrathin-film composite membrane according to Example 11 shows excellent performance as a separation membrane and can be applied to a pressure retarded osmosis or forward osmosis process and used as an organic solvent nano-filtration membrane by virtue of its excellent heat resistance and chemical resistance of the support.

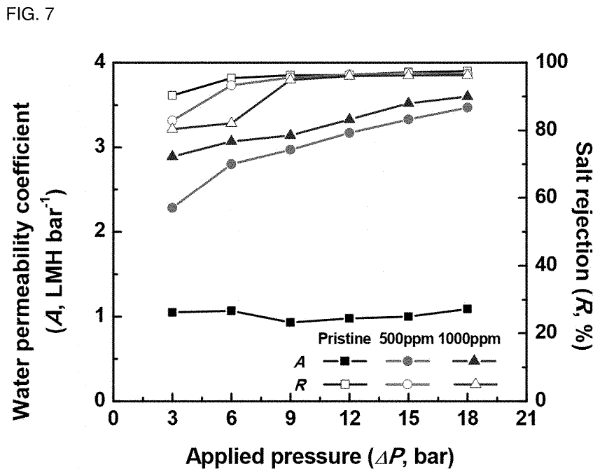

In addition, FIG. 7 is a graph illustrating the water permeance and salt rejection ratio of the ultrathin-film composite membrane according to Example 11 before and after the post-treatment (500 ppm NaOCl, 1000 ppm NaOCl) [charge: 2000 ppm NaCl (20° C.)]. After carrying out treatment with NaOCl, it is possible to improve water permeance by about at least two times or more, while not adversely affecting the salt rejection ratio. Thus, it can be seen that the ultrathin-film composite membrane according to the present disclosure is suitable for a forward osmosis process.

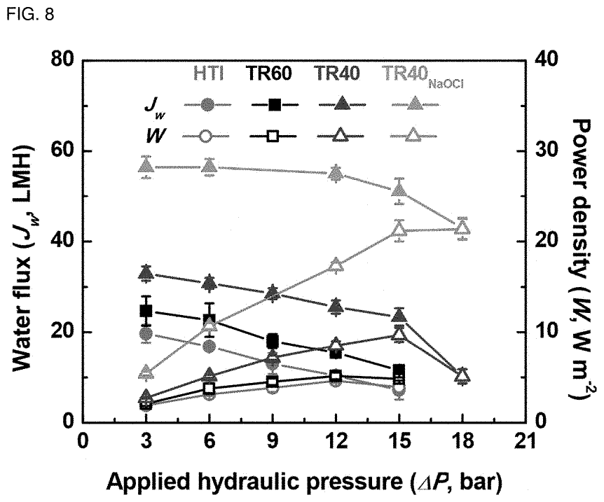

Further, FIG. 8 is a graph illustrating the water flux and power density of the ultrathin-film composite membrane according to an embodiment of the present disclosure [inducing solution: 1M NaCl (20° C.), charge: deionized water (20° C.), conventional polysulfone-based ultrathin-film composite membrane (HTI) available from Hydration Technology Innovations, ultrathin-film composite membranes according to the present disclosure TR 40 (thickness 40 μm), TR 60 (thickness 60 μm), TR40_{NaOCl} (thickness 40 μm, treated with 1000 ppm of NaOCl for 10 minutes]. As shown in FIG. 8, while the conventional HTI shows a low power density of 5 W/m², the ultrathin-film composite membrane (TR40_{NaOCl}) according to the present disclosure provides a high power density up to 21 W/m². In addition, after comparing TR40 with TR 60 in order to determine the resistance of the support depending on thickness, it can be seen that TR40 reduces mass transport resistance and shows high power density.

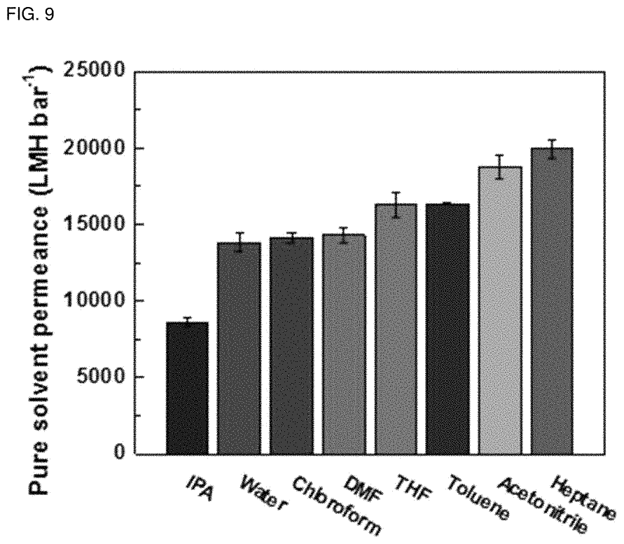

FIG. 9 is a graph illustrating the pure solvent permeance test results of the porous thermally rearranged poly(benzoxazole-imide) copolymer support according to Example 1. As shown in FIG. 9, while the permeance test is carried out by using various organic solvents, such as isopropyl alcohol (IPA), distilled water, chloroform, dimethyl formamide (DMF), tetrahydrofuran (THF), toluene, acetonitrile and heptane, the support shows high chemical resistance and high pure solvent permeance derived from high porosity. Thus, it can be seen that the support can be used not only as a support for organic solvent nano-filtration but also as an organic solvent nano-filtration membrane by virtue of its chemical resistance and heat resistance.

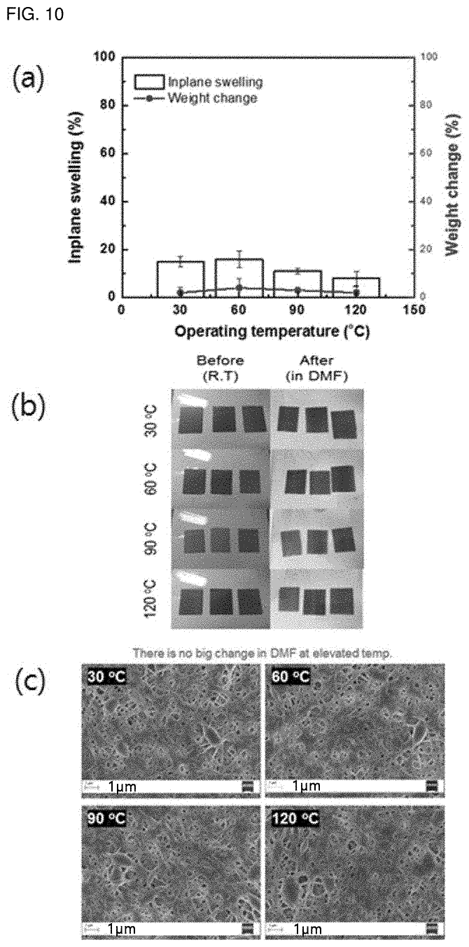

In addition, FIG. 10 illustrates the results of the observing a change in shape and structure of the porous thermally rearranged poly(benzoxazole-imide) copolymer support according to Example 1 in high-temperature DMF [(a) graph of dimensional change, (b) photograph taken by the naked eyes, (c) scanning electron microscopic (SEM) image] to determine the heat resistance and chemical resistance. Even under more severe conditions including high temperature (30° C., 60° C., 90° C., 120° C.) and DMF as a solvent, the support causes no significant change in terms of dimension, observation by naked eyes and scanning electron microscopic (SEM) images.

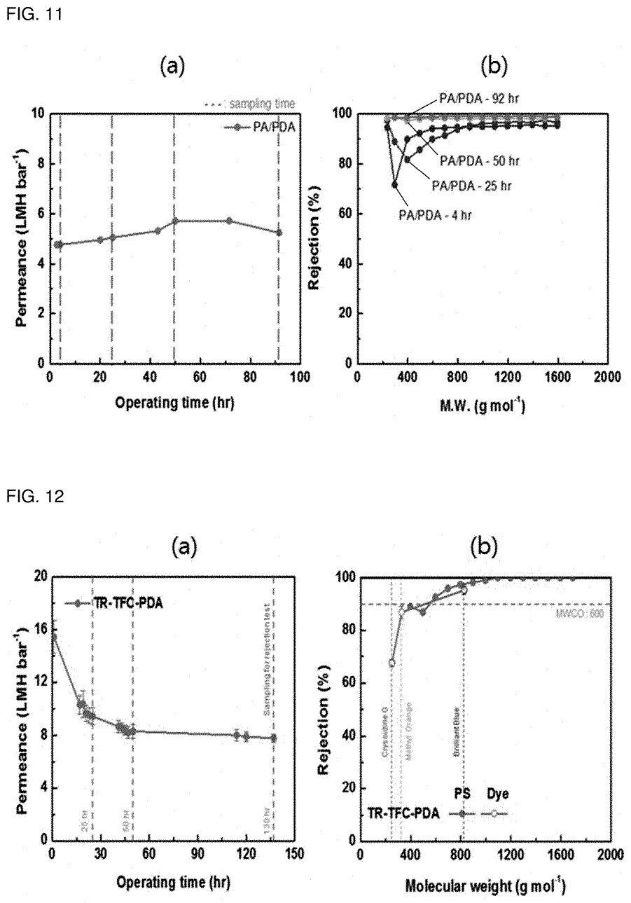

Further, FIG. 11 is a graph illustrating the THF permeance (a) and rejection ratio (b) of the ultrathin-film composite membrane according to Example 11. The test was carried out by using a volumetric cylinder in a polystyrene/THF solution at 30° C. under 30 bars with a flow rate of 50 L/hr. The permeate and charge were collected in the same manner to determine the rejection ratio by using HPLC-UV/Vis. As can be seen from FIG. 11, the ultrathin-film composite membrane shows a high permeance of 5 LMH/bar and a rejection ratio of at least 99% vs. polystyrene having a molecular weight of 236-1600 g/mol.

In addition, FIG. 12 is a graph illustrating the DMF permeance (a) and rejection ratio (b) of the ultrathin-film composite membrane according to Example 11. The test was carried out by using a volumetric cylinder in a 2 g/L polystyrene/DMF solution and 1 g/L dye solution at 30° C. under 30 bar with a flow rate of 50 L/hr. The dyes used for the test were Chrysoidine G (− charge, 249 g/mol), Methylene Orange (+ charge, 327 g/mol) and Brilliant Blue (+ charge, 826 g/mol). When carrying out the test, the volume of the permeate for a predetermined time was measured in the same manner as described above to calculate the permeance. The dye rejection ratio was determined by observing a difference in wavelength through UV spectroscopy. As can be seen from FIG. 12, the ultrathin-film composite membrane shows a high permeance of about 8 LMH/bar. It can be also seen that the rejection ratio profile depends on solute size regardless of the type of a charge.

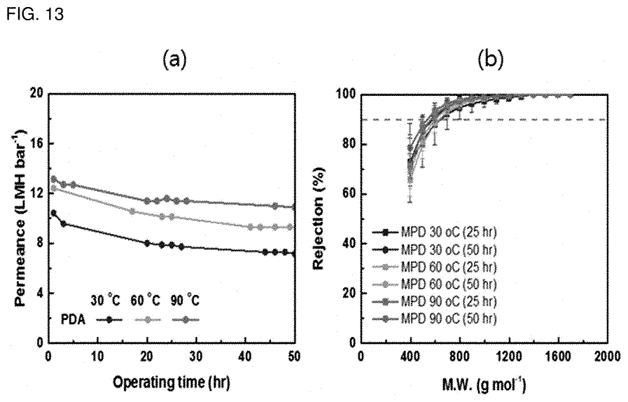

In addition, FIG. 13 is a graph illustrating the high-temperature DMF permeance (a) and rejection ratio (b) of the ultrathin-film composite membrane according to Example 11. The ultrathin-film composite membrane according to Example 11 shows stable and excellent performance even under more severe conditions including high temperature (30° C., 60° C., 90° C.) and DMF as a solvent. In other words, since the solvent viscosity is decreased as the system temperature is increased, the permeance is increased while causing little change in rejection ratio. It is thought that since the active layer and support have excellent chemical stability even at high temperature, only the permeance is increased while the rejection ratio is maintained. This suggests that the ultrathin-film composite membrane can be used as an organic solvent nano-filtration membrane even under severe conditions.

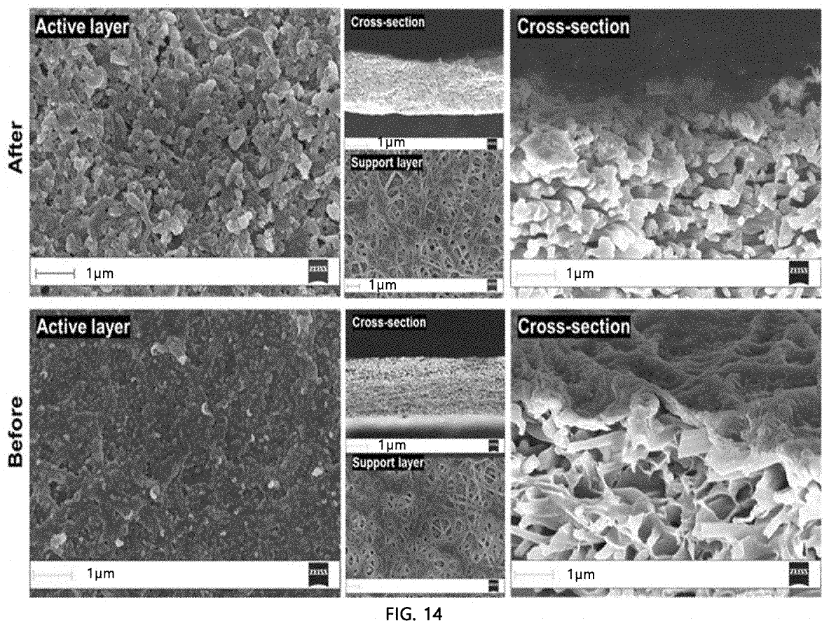

Further, FIG. 14 is a scanning electron microscopic (SEM) image of the morphology of the ultrathin-film composite membrane according to Example 11, taken before and after using the membrane as an organic solvent nano-filtration membrane. There is no significant change in SEM images before and after using the membrane as an organic solvent nano-filtration membrane. Thus, it can be seen that the ultrathin-film composite membrane according to the present disclosure has excellent stability.

### INDUSTRIAL APPLICABILITY

As described above, the ultrathin-film composite membrane including a thin-film active layer formed on a thermally rearranged poly(benzoxazole-imide) copolymer support has excellent thermal/chemical stability and mechanical properties so that it can resist even under high operating pressure, minimizes internal concentration polarization to provide high water permeance and high power density according thereto so that it may be applied to a pressure retarded osmosis or forward osmosis process. In addition, the ultrathin-film composite membrane shows excellent chemical/thermal stability against organic solvents, and particularly maintains nano-filtration performance even under the condition of a high-temperature organic solvent so that it may be applied to an organic solvent nano-filtration process.

1. An ultrathin-film composite membrane comprising:
a porous thermally rearranged poly(benzoxazole-imide) copolymer support having a repeating unit represented by the following Chemical Formula 1; and
a thin-film active layer formed on the support. 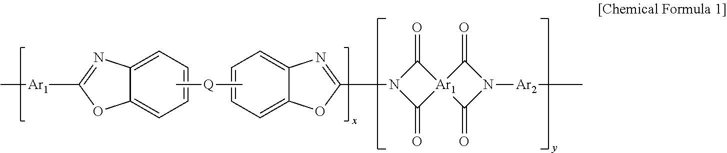
wherein Ar₁ is an aromatic cyclic group selected from a substituted or non-substituted tetravalent C6-C24 arylene group and a substituted or non-substituted tetravalent C4-C24 heterocyclic group, wherein the aromatic cyclic group is present alone; two or more aromatic cyclic groups may form a condensed ring; or two or more aromatic cyclic groups may be linked by means of a single bond, O, S, CO, SO₂, Si(CH₃)₂, (CH₂) (1≤P≤10), (CF₂)_{q} (1≤q≤10), C(CH₃)₂, C(CF₃)₂ or CO—NH;
Ar₂ is an aromatic cyclic group selected from a substituted or non-substituted divalent C6-C24 arylene group and a substituted or non-substituted divalent C4-C24 heterocyclic group, wherein the aromatic cyclic group is present alone; two or more aromatic cyclic groups may form a condensed ring; or two or more aromatic cyclic groups may be linked by means of a single bond, O, S, CO, SO₂, Si(CH₃)₂, (CH₂)ₚ (1≤P≤10), (CF₂)_{q} (1≤q≤10), C(CH₃)₂, C(CF₃)₂ or CO—NH;
Q is a single bond, O, S, CO, SO₂, Si(CH₃)₂, (CH₂)ₚ (1≤P≤10), (CF₂)_{q} (1≤q≤10), C(CH₃)₂, C(CF₃)₂, CO—NH, C(CH₃)(CF₃), or substituted or non-substituted phenylene group; and
each of x and y represents a molar fraction in the repeating unit, wherein 0.1≤x≤0.9, 0.1≤y≤0.9, and x+y=1.

2. The ultrathin-film composite membrane according to claim 1, wherein the porous thermally rearranged poly(benzoxazole-imide) copolymer support is an electrospun membrane or hollow fiber membrane.

3. The ultrathin-film composite membrane according to claim 2, wherein the electrospun membrane has a thickness of 10-80 μm and a porosity of 60-80%.

4. The ultrathin-film composite membrane according to claim 1, wherein the active layer of the thin-film is an aromatic polyamide having a repeating unit represented by the following Chemical Formula 2:

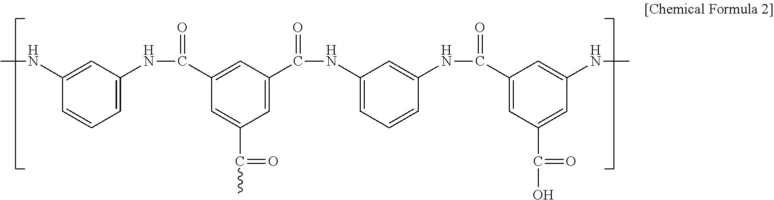

5. The ultrathin-film composite membrane according to claim 4, wherein the active layer of the thin-film has a thickness of 50-300 nm.

6. The ultrathin-film composite membrane according to claim 1, which is for use in a pressure retarded osmosis process.

7. The ultrathin-film composite membrane according to claim 1, which is for use in a forward osmosis process.

8. The ultrathin-film composite membrane according to claim 1, which is for use in nano-filtration of organic solvents.

9. A method for producing an ultrathin-film composite membrane, comprising the steps of:
I) carrying out reaction of acid dianhydride, ortho-hydroxydiamine and aromatic diamine to obtain polyamic acid solution and forming a hydroxyl group-containing polyimide-polyimide copolymer through an azeotropic thermal imidization process;
II) forming a membrane from a polymer solution containing the hydroxyl group-containing polyimide-polyimide copolymer of step I) dissolved in an organic solvent through an electrospinning process or non-solvent induced phase separation process;
III) carrying out thermal rearrangement of the membrane obtained from step II) to obtain a porous thermally rearranged poly(benzoxazole-imide) copolymer support having a repeating unit represented by the above Chemical Formula 1; and
IV) forming an active layer on the support by using a crosslinked aromatic polyamide thin film having a repeating unit represented by the above Chemical Formula 2.

10. The method for producing an ultrathin-film composite membrane according to claim 9, wherein the acid dianhydride in step I) is represented by the following Chemical Formula 3: 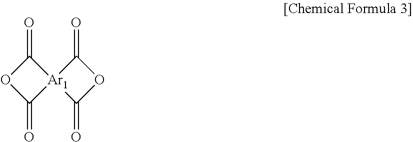
wherein Ar₁ is the same as defined in the above Chemical Formula 1.

11. The method for producing an ultrathin-film composite membrane according to claim 9, wherein the ortho-hydroxydiamine in step I) is represented by the following Chemical Formula 4: 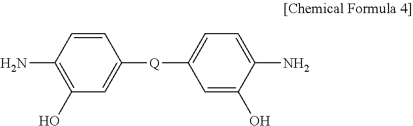
wherein Q is the same as defined in the above Chemical Formula 1.

12. The method for producing an ultrathin-film composite membrane according to claim 9, wherein the aromatic diamine in step I) is represented by the following Chemical Formula 5:
H₂N—Ar₂—NH₂ [Chemical Formula 5]
wherein Ar₂ is the same as defined in the above Chemical Formula 1.

13. The method for producing an ultrathin-film composite membrane according to claim 9, wherein the thermal rearrangement in step III) is carried out by increasing the temperature to 300-400° C. at a warming rate of 1-20° C./min and maintaining the isothermal state for 1-2 hours under a high purity inert gas atmosphere.

14. The method for producing an ultrathin-film composite membrane according to claim 9, which further comprises a step of carrying out hydrophilization treatment of the support obtained from step III) before carrying out step Iv).

15. The method for producing an ultrathin-film composite membrane according to claim 9, which further comprises a step of carrying out post-treatment of the ultrathin-film composite membrane obtained from step IV) with aqueous sodium hypochlorite.
